(19) United States
(12) Patent Application Publication
(10) Pub. No.: US 2007/0091452 A1
(43) Pub. Date: Apr. 26, 2007

(54) Projection system and method

(76) Inventors: Scott Lerner, Corvallis, OR (US); Anurag Gupta, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/257,743

(22) Filed: Oct. 25, 2005

(51) Int. Cl. G02B 3/00; G02B 9/00

(52) U.S. Cl. 359/649

(57) ABSTRACT

A projection system including an illumination source providing an illumination beam, a modulator configured to modulate the illumination beam based on an image signal to form an image beam, and a projection lens having an aberration profile and comprising a catadioptric lens. The image signal is adjusted based on the aberration profile of the projection lens. The catadioptric lens is configured to receive the image beam along a first optical axis and fold and direct the image beam along a second optical axis such that a fold angle between the first and second optical axes is within a desired range.

### BACKGROUND

Digital light processing (DLP) projectors typically include an illumination system, some type of spatial light modulator (SLM), and a projection lens. The illumination system generally includes a light source which generates light and a reflector which directs the light from the light source to the SLM. The SLM forms an image beam by modulating the light, either via reflection (e.g. a digital micro-mirror device (DMD)) or transmission (e.g. a liquid crystal modulator), based on a data signal representative of the desired images to be projected. The projection lens receives and projects the image beam onto a projection surface, such as a projection screen, for viewing.

Projection lenses are typically designed to provide a desired magnification, or range of magnifications (i.e. zoom lens), and to minimize optical aberrations (e.g. chromatic aberrations, coma, diffraction, and geometric distortions) in order to provide a high quality projected image. In efforts to minimize such optical aberrations, projection lenses typically comprise complex systems of multiple lens elements arranged in a specific sequence which is often linear or barrel-like in configuration. Such projection lenses are often costly and may consume a relatively large amount of space within the projector.

### SUMMARY

One form of the present invention provides a projection system including an illumination source providing an illumination beam, a modulator configured to modulate the illumination beam based on an image signal to form an image beam, and a projection lens having an aberration profile and comprising a catadioptric lens. The image signal is adjusted based on the aberration profile of the projection lens. The catadioptric lens is configured to receive the image beam along a first optical axis and fold and direct the image beam along a second optical axis such that a fold angle between the first and second optical axes is within a desired range.

### BRIEF DESCRIPTION OF THE DRAWINGS

FIG. 1 is a block diagram illustrating a projection system according to one embodiment of the present invention.

FIG. 2 is a schematic diagram illustrating one exemplary embodiment of a projection lens according to the present invention.

FIG. 3 is a schematic diagram illustrating one exemplary embodiment of a projection lens according to the present invention.

FIG. 4 is a schematic diagram illustrating one exemplary embodiment of a projection lens according to the present invention.

FIG. 5 is a flow diagram illustrating one embodiment of a method of operating a projector in accordance with the present invention.

### DETAILED DESCRIPTION

In the following detailed description of the preferred embodiments, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

As described herein, a projection lens is provided for a digital projector that folds a modulated image beam at a fold angle that is within a desired range using a catadioptric lens, wherein the image beam is modulated based on optical distortion characteristics of the projector including distortion characteristics of the projection lens. By folding the image beam in this fashion and modulating the image beam based on optical distortion characteristics of the projector, the projection lens has a folded architecture which is more compact in size relative to conventional projection lenses which, in-turn, enables a more compact digital projector relative to conventional digital projectors.

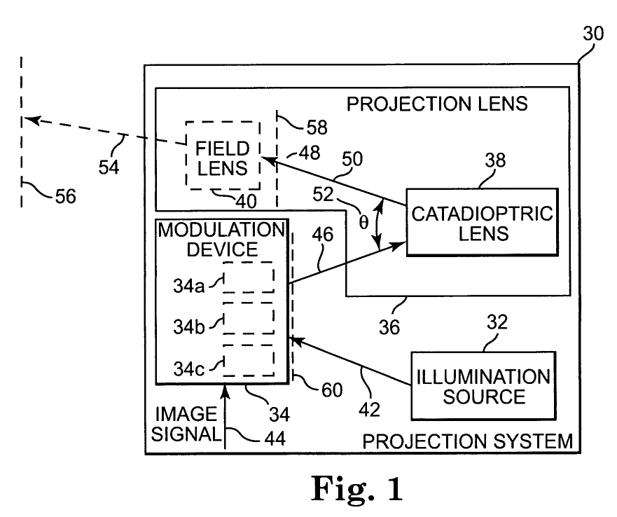

FIG. 1 is a block diagram illustrating one embodiment of a projection system 30 in accordance with the present invention. Projection system 30 includes an illumination source 32, a modulation device 34, and a projection lens 36 including a catadioptric lens 38 according to one embodiment of the present invention.

In one embodiment, illumination source 32 generates and directs an illumination beam along an illumination path 42 to modulation device 34 at a non-zero angle of incidence and in a fashion such that modulation device 34 is uniformly illuminated. Illumination source 32 may include a mercury ultra high pressure, xenon, metal halide, or other suitable projector lamp that provides a monochromatic or polychromatic illumination beam. In one embodiment, illumination source 32 comprises light emitting diodes (LEDs) configured to provide separate light components (e.g. red, green, and blue). Illumination source 32 may comprise any type of architecture generally known to those skilled in the art such as, for example, prism-based architectures and field lens based architectures.

In one embodiment, modulation device 34 modulates the illumination beam based on an image signal 44 to form an image beam which is directed to projection lens 36 along a first projection path having a first optical axis 46. Modulation device 34 comprises at least one SLM such as a transmissive-type modulator (e.g. liquid crystal display (LCD)), a digital light processing (DLP) type modulator (e.g. digital micro-mirror device (DMD)), or other suitable SLM which transmits or reflects selected portions of the illumination beam based on image signal 44. In one embodiment, illumination source 32 provides and separates the illumination beam along illumination path 42 into separate illumination components (e.g. red, green, and blue), with modulation device 34 including separate SLMs 34a, 34b, and 34c positioned to receive and modulate a corresponding illumination component.

In one embodiment, as described in greater detail below, catadioptric lens 38 includes at least a first refractive surface and a reflective last surface. Catadioptric lens 38 receives the image beam along optical axis 46 of the first projection path into the first refractive surface and, through refraction by the first refractive surface and reflection by the reflective last surface, folds and directs the image beam to an exit pupil 48 along a second projection path having a second optical axis 50.

In one embodiment, catadioptric lens 38 folds the image beam such that a fold angle (θ) 52 between first and second optical axes 46, 50 is within a desired range of angles. In one exemplary embodiment, the desired range of angles ranges from approximately 10 degrees to approximately 120 degrees. Although, as illustrated, exit pupil 48 appears to be positioned in a plane defined by modulation device 34 and catadioptric lens 38, exit pupil 48 can be positioned outside such a plane (e.g. into/out of the page on which FIG. 1 is drawn) such that fold angle 52 comprises a compound fold angle.

In one embodiment, as illustrated by the dashed lines in FIG. 1, projection lens 36 further includes a field lens 40. Field lens 40 is positioned proximate to exit pupil 48 and is configured to receive the image beam along optical axis 50 of the second projection path and to project the image beam along a projection path 54 to a projection surface 56, such as a projection screen, for example. In one embodiment, catadioptric lens 38 is configured such that a plane 58 of exit pupil 48 substantially coincides with a modulation plane 60 of modulation device 34. It is noted that when projection lens 36 does not employ a field lens, such as field lens 40, catadioptric lens 38 may be configured to direct and project the image beam along optical axis 50 of the second projection path directly onto projection surface 56.

In one embodiment, projection lens 36 is configured to magnify and relay an image of modulation device 34 (i.e. the image beam) onto projection surface 56 for viewing. Ideally, projection lens 36 forms an exact image, albeit enlarged (i.e. magnified), of modulation device 34 on projection surface 56. The actual image projected by projection lens 36 onto projection surface 56, however, may deviate from the exact image. The deviations of the projected image from the ideal image are referred to as lens aberrations. As known to those skilled in the art, lens aberrations include, for example, field curvature, chromatic aberration, coma, spherical aberration, distortion (e.g. barrel and pincushion distortion), and lateral color. In one embodiment, the distortion and lateral color aberration characteristics of projection lens 36 are referred to as the aberration profile of projection lens 36.

In one embodiment, projection lens 36 is configured to provide a high quality resolution or modulation transfer function (MTF) with a known aberration profile. In one exemplary embodiment, the aberration profile of projection lens 36 is empirically determined at manufacture. As such, in one embodiment, image signal 44 is algorithmically adjusted or “pre-distorted” based on the aberration profile of projection lens 36 so as to counteract or pre-correct distortions such that distortion and lateral color aberrations that would otherwise be introduced by projection lens 36 are substantially reduced and/or eliminated from the projected image as displayed on projection surface 56.

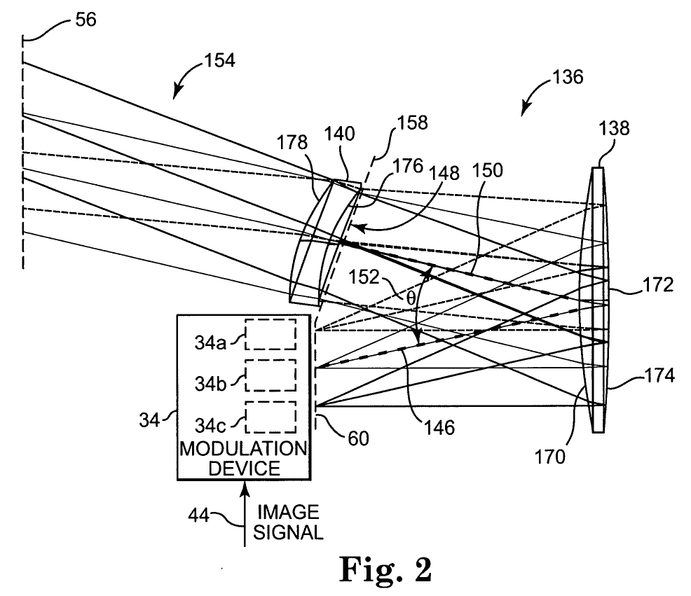

By pre-processing image signal 44 to pre-correct the image data to compensate for or to counteract known distortion and lateral color aberration characteristics, the required distortion and lateral color tolerances of projection lens 36 can be relaxed. As a result, the complexity of projection lens 36 can be reduced relative to conventional projection lenses, thereby reducing expense and enabling a more compact lens architecture relative to conventional projection lenses. An example of such a compact lens architecture includes the folded architecture employing catadioptric lens 38 as described above with reference to FIG. 1 and described in greater detail below with reference to FIGS. 2-4.

FIG. 2 is a schematic diagram illustrating one embodiment of portions of projection system 30 of FIG. 1 and illustrating one embodiment of a projection lens 136 according to the present invention. In one embodiment, projection lens 136 includes a catadioptric lens 138 and a field lens 140. As illustrated in the embodiment of FIG. 2, modulation device 34 provides an illumination beam along a first optical axis 146 into catadioptric lens 138 based on image signal 44 which, as described above, is adjusted based on an aberration profile of projection lens 136.

In one embodiment, catadioptric lens 138 includes a refractive front surface 170 and a rear surface 172 coated with a reflective material 174 such that rear surface 172 is a reflective surface. In one embodiment, catadioptric lens 172 comprises a bi-convex lens with both front surface 170 and rear surface 172 being aspheric in shape. In one embodiment, catadioptric lens 138 is centered on optical axis 146 and receives the image beam into front surface 170 such that front surface 170 refracts the image beam, rear surface 172 reflects the image beam, and front surface 170 again refracts and directs the image beam along a second illumination path having a second optical axis 150 to an exit pupil 148 at a pupil plane 158, such that a fold angle (θ) 152 between first optical axis 146 and second optical axis 150 is within a desired range.

In one embodiment, field lens 140 is positioned proximate to exit pupil 148 and includes a refractive surface 176 and a refractive surface 178. In one embodiment, field lens 140 comprises a negative meniscus type lens with refractive surface 176 being aspheric concave in shape and refractive surface 178 being aspheric convex in shape. In one embodiment, field lens 140 is configured to receive the image beam along optical axis 150 of the second projection path and to project the image beam along a projection path 154 to projection surface 56 for viewing. In one embodiment, field lens 140 is of low power relative to catadioptric lens 138 and is configured primarily to provide aberration correction in projection lens 136.

As illustrated in the embodiment of FIG. 2, catadioptric lens 138 is configured such that pupil plane 158 substantially coincides with modulation plane 60 of modulation device 34 so as to provide a compact spacing between field lens 140 and modulation device 34. Catadioptric lens 138, however, need not be so configured whereby exit pupil 148 can be located as desired at any number of positions.

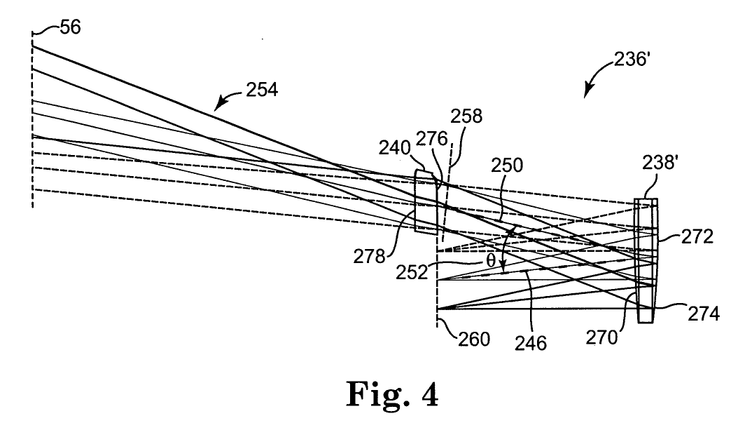

Although illustrated in the embodiment of FIG. 2 as being aspheric and bi-convex in shape, catadioptric lens 138 may comprise any number of shapes and configurations such as, for example, symmetric, asymmetric (e.g. wedge-shaped, see FIG. 4), spherical, aspheric (e.g. elliptical, parabolic, etc.). Additionally, although illustrated as comprising a single lens element having a single refractive surface 170, catadioptric lens 138 may comprise multiple lens elements having multiple refractive surfaces (e.g. multiple cemented lens elements) positioned between reflective surface 172 and modulation plane 60. Similarly, field lens 140 may comprise any number of shapes and configurations and may comprise multiple lenses and/or mirrors.

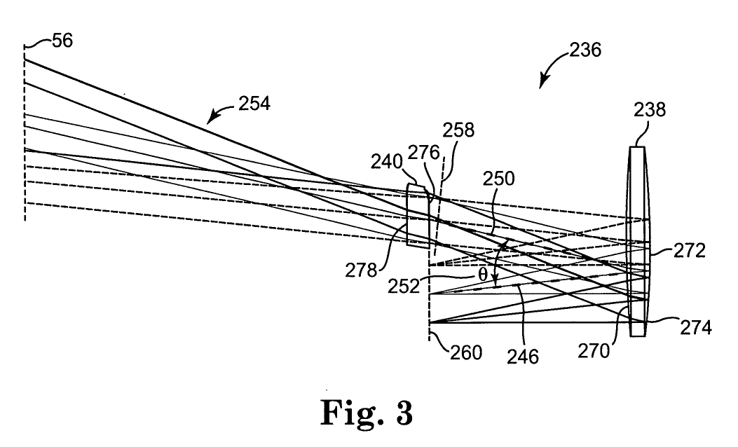

FIG. 3 is a schematic diagram illustrating one embodiment of a projection lens 236 according to the present invention. In one embodiment, projection lens 236 includes a catadioptric lens 238 and a field lens 240. In one embodiment, catadioptric lens 238 receives an image beam from a corresponding entrance pupil 260 along a projection path having a first optical axis 246. The image beam is brought to entrance pupil 260 from a modulation device (such as modulation device 34 of FIG. 1) which generates the image beam based on an image signal which is adjusted based on a corresponding aberration profile of projection lens 236.

In one embodiment, catadioptric lens 238 includes a refractive front surface 270 and a rear surface 272 coated with a reflective material 274 so that rear surface 272 is a reflective surface. In one embodiment, both front surface 270 and rear surface 272 are convex in shape. In one embodiment, catadioptric lens 238 is configured to be de-centered or off-axis from first optical axis 246. Catadioptric lens 238 receives the image beam into front surface 270 such that front surface 270 refracts the image beam, rear surface 272 reflects the image beam, and front surface 270 again refracts and directs the image beam along a second illumination path having a second optical axis 250 to an exit pupil 248 at a pupil plane 258, such that a fold angle (θ) 252 between first optical axis 246 and second optical axis 250 is within a desired range.

In one embodiment, field lens 240 is positioned proximate to exit pupil 248 and includes a refractive surface 276 and a refractive surface 278. Field lens 240 is configured to receive the image beam along optical axis 250 and project the image beam to projection surface 56 along a projection path 254. In one embodiment, field lens 240 comprises an asymmetric lens, having been truncated or “cut-off” in an asymmetric fashion opposite an optical axis so as further compact the architecture of projection lens 236.

FIG. 4 is a schematic diagram illustrating another embodiment of projection lens 236. Projection lens 236′ is similar to projection lens 236 and includes a catadioptric lens 238′ and a field lens 240. In one embodiment, as illustrated in FIG. 4, catadioptric lens 238′ is truncated in a fashion similar to that described above with respect to field lens 240, such that catadioptric lens 238′ comprises an asymmetric “wedge-shaped” lens that further compacts the architecture of projection lens 236.

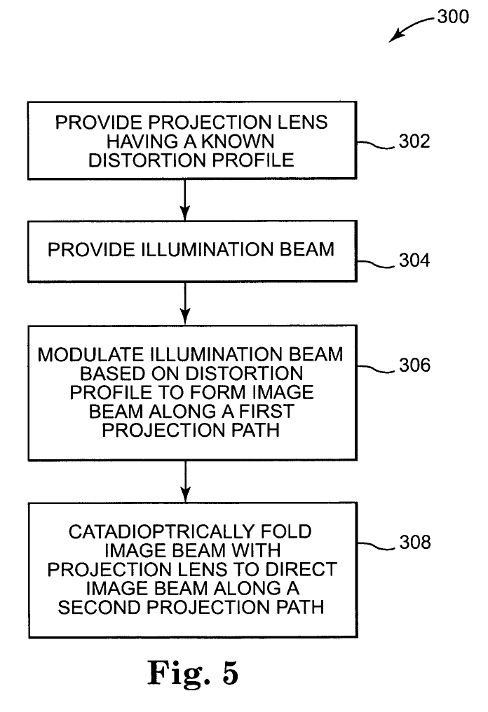

FIG. 5 is a flow diagram illustrating one embodiment of a method 300 of operating a digital projector in accordance with the present invention. Method 300 begins at 302 where a projection lens with a known aberration profile is provided, such as projection lenses 36, 136, 236, and 236′ as described above and respectively illustrated by the embodiments FIGS. 1-4.

At 304, an illumination beam is provided, such as by illumination source 32 as described above with reference to FIG. 1. At 306, the illumination beam is modulated, for example, by modulation device 34 (FIGS. 1 and 2) based on the aberration profile of the projections lens to provide an image beam along a first projection path having a first optical axis.

At 308, the illumination beam along the first projection path is catadioptrically folded by the projection lens, such as by catadioptric lenses 38, 138, 238, and 238′ of the embodiments of FIGS. 1-4, so as to direct the image beam along a second projection path having a second optical axis. In one embodiment, the second optical axis forms a fold angle with the first optical axis that is within a desired range of angles, and, in one embodiment, the image beam forms an optical pupil along the second projection path which substantially coincides with a modulation plane of the modulation device. In one exemplary embodiment, the desired range of angles of the fold angle is between approximately ten degrees and approximately one hundred twenty degrees.

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A projection system, comprising:
an illumination source providing an illumination beam;
a modulator configured to modulate the illumination beam based on an image signal to form an image beam; and
a projection lens having an aberration profile and comprising a catadioptric lens, wherein the image signal is adjusted based on the aberration profile of the projection lens, and wherein the catadioptric lens is configured to receive the image beam along a first optical axis and fold and direct the image beam along a second optical axis such that a fold angle between the first and second optical axes is within a desired range.

2. The projection system of claim 1, wherein the desired range of the fold angle is between approximately ten degrees and approximately one-hundred twenty degrees.

3. The projection system of claim 1, wherein the fold angle comprises a compound fold angle.

4. The projection system of claim 1, wherein the catadioptric lens is substantially centered on the first and second optical axes.

5. The projection system of claim 1, wherein the catadioptric lens is off-axis relative to the first and second optical axes.

6. The projection system of claim 1, wherein the catadioptric lens is configured to direct the image beam to an exit pupil along the second optical axis, wherein a plane of the exit pupil substantially coincides with a modulation plane of the modulator.

7. The projection system of claim 1, wherein the catadioptric lens comprises a single lens element having a first refractive surface and a second surface coated with a reflective material.

8. The projection system of claim 7, wherein the single lens element comprises a wedge-shaped lens element.

9. The projection system of claim 1, wherein the catadioptric lens comprises a plurality of refractive surfaces and a last surface which is reflective.

10. The projection system of claim 9, wherein the catadioptric lens comprises a plurality of surfaces and elements.

11. The projection system of claim 1, wherein the projection lens further comprises a field lens positioned along the second optical axis, wherein the field lens is configured to receive and project the image beam along a third optical axis to a projection surface for viewing.

12. The projection system of claim 11, wherein the field lens comprises a plurality of lenses.

13. The projection system of claim 11, wherein the field lens comprises a plurality of mirrors.

14. A method of operating a projection system, the method comprising:
providing a projection lens having an aberration profile and including a catadioptric lens;
modulating an illumination beam based on the aberration profile of the projection lens and forming an image beam along a first projection path having a first optical axis; and
folding the image beam with the catadioptric lens and directing the image beam along a second projection path having a second optical axis, wherein the second optical axis forms a fold angle with the first optical axis which is within a desired range of angles.

15. The method of claim 14, wherein the desired range of angles is between approximately ten degrees and approximately one-hundred twenty degrees.

16. The method of claim 14, wherein folding the image beam includes directing the image beam to an exit pupil along the second optical axis.

17. The method of claim 16, wherein directing the image beam to the exit pupil includes positioning the exit pupil in a plane which substantially coincides with a modulation plane.

18. The method of claim 16, wherein providing the projection lens further includes:
providing a field lens;
positioning the field lens proximate to the exit pupil; and
projecting the image beam onto a projection surface with the field lens.

19. A projection system, comprising:
means for providing an illumination beam;
means for modulating the illumination beam and forming an image beam along a first projection path having a first optical axis; and
means for catadioptrically folding the image beam and directing the image beam along a second projection path having a second optical axis, wherein the second optical axis forms a fold angle with the first optical axis that is within a desired range of fold angles,
wherein the means for catadioptrically folding the image beam has an aberration profile, and wherein the means for modulating the illumination beam includes means for modulating the illumination beam based on the aberration profile.

20. The projection system of claim 19, wherein the means for catadioptrically folding the image beam includes means for receiving the image beam from the second projection path and projecting the image beam onto a projection surface.

21. A projection system, comprising:
a projection lens having a known aberration profile and including:
a catadioptric lens having at least a first refractive surface and a reflective last surface; and
a field lens;
an illumination source providing an illumination beam; and
a modulator configured to modulate the illumination beam based on an image signal to form an image beam, wherein the image signal is adjusted based on the aberration profile of the projection lens, wherein the modulator is adapted to project the image beam along a first optical axis into the first refractive surface of the catadioptric lens, wherein the catadioptric lens is configured to fold and direct the image beam along a second optical axis such that a fold angle between the first and second optical axes is within a desired range, and wherein the field lens is positioned along the second optical axis and configured to project the image beam to a projection surface.

22. The projection system of claim 21, wherein the desired range of the fold angle is between approximately ten degrees and approximately one-hundred twenty degrees.

23. The projection system of claim 21, wherein the catadioptric lens comprises a single lens element having the first refractive surface and a second surface coated with a reflective material forming the reflective last surface.

24. The projection system of claim 21, wherein the catadioptric lens comprises a plurality of refractive surfaces including the first refractive surface and the reflective last surface.

25. The projection system of claim 21, wherein the catadioptric lens and the field lens each comprise a plurality of surfaces.

26. The projection system of claim 21, wherein at least one of the catadioptric lens and the field lens comprise aspheric surfaces.

27. The projection system of claim 21, wherein the catadioptric lens is centered on the first and second optical axes and the field lens is centered on the second optical axis.

28. The projection system of claim 21, wherein at least one of the catadioptric lens and the field lens is positioned off-axis relative to the first and second optical axes.

29. A projection lens, comprising:
a catadioptric lens having at least a first refractive surface and a reflective last surface; and
a field lens positioned in an optical path with the catadioptric lens, wherein the catadioptric lens and the field lens together have a known aberration profile,
wherein the catadioptric lens is configured to receive an image beam adjusted based on the aberration profile along a first optical axis via the first refractive surface and configured to fold and direct the image beam to an exit pupil along a second optical axis such that a fold angle between the first and second optical axes is within a desired range, and wherein the field lens is positioned proximate the exit pupil and configured to receive and direct the image beam along a third optical axis to a projection surface.

30. The projection lens of claim 29, wherein the desired range of the fold angle is between approximately ten degrees and approximately one-hundred twenty degrees.
